(19) United States
(12) Patent Application Publication
(10) Pub. No.: US 2007/0041211 A1
(43) Pub. Date: Feb. 22, 2007

(54) Diffusers and methods of manufacturing

(76) Inventors: Zhijian Lu, Belle Mead, NJ (US); John N. Magno, Middletown, NJ (US); Gene C. Koch, Bayville, NJ (US)

Correspondence Address: RONALD D. TRICE, 6412 BRANDON AVE., # 145, SPRINGFIELD, VA, 22150, US

(21) Appl. No.: 11/432,713

(22) Filed: May 12, 2006

Related U.S. Application Data
(60) Provisional application No. 60/681,143, filed on May 16, 2005.

(51) Int. Cl. G02B 5/02

(52) U.S. Cl. 362/558

(57) ABSTRACT

A structure including an integrally formed diffuser may be formed by depositing a first layer including a first polymerizable material and another material, and depositing a second layer including a second polymerizable material adjacent the first layer. The first and second layers are simultaneously irradiated with light that causes the first polymerizable material and the second polymerizable material to polymerize. There is not an optical boundary between the first and second layers since the first and second materials are polymerized together.

### RELATED APPLICATIONS

This application claims priority from, and incorporates by reference, U.S. Provisional Application Ser. No. 60/681,143, filed May 16, 2005.

### FIELD OF THE INVENTION

The present invention relates generally to diffusers and methods of manufacturing, and more particularly, to diffusers including integrally formed diffusing elements and waveguides and methods of manufacturing.

### BACKGROUND

Optical diffusers are one of the components in projection displays, liquid crystal displays and other devices. The screens of such display devices receive light and then spread the light to a wider angular range through one or more diffusers. In some cases the diffuser is a separate layer or element while in other cases the diffuser is formed on another layer or element. These diffusers are formed by additional processing and/or fabrication steps performed on the layer or element that will form the diffuser and may have other problems. Accordingly, there is a strong need in the art for a diffuser that is formed with a minimal or no additional processing and/or fabrication steps while having minimal or no other problems.

### SUMMARY OF THE INVENTION

An aspect of the present invention is to provide a diffuser structure including a structure having at least a first part and a second part, the first part diffusing light passing through the first part and including at least a first material, the second part providing at least one function other than diffusing light passing through the second part and including at least a second material. The at least a portion of the at least a first material adjacent the second part is crosslinked to at least a portion of the at least a second material adjacent the first part.

Another aspect of the invention is to provide a diffuser structure including integrally formed diffusing elements including a polymerized structure including a diffusing part and another part, the diffusing part and the another part being integrally formed.

Another aspect of the invention is to provide a method of forming an integrated diffuser including depositing a first layer including a first polymerizable material and another lo material, depositing a second layer including a second polymerizable material adjacent the first layer, and simultaneously irradiating the first layer and the second layer with light that causes the first polymerizable material and the second polymerizable material to polymerize. The another material causes light diffusion once the first polymerizable material is polymerized by the simultaneously irradiating.

### BRIEF DESCRIPTION OF THE DRAWINGS

The invention will be described in detail with reference to the following drawings in which like reference numerals refer to like elements wherein:

FIG. 1 illustrates a first step of forming an exemplary diffuser according to the present invention;

FIG. 2 illustrates a second step of forming an exemplary diffuser according to the present invention;

FIG. 3 illustrates a partially completed diffuser after completion of the second step;

FIG. 4 illustrates a completed diffuser after removal of the unpolymerized material in a second step;

FIG. 5 illustrates another completed diffuser incorporating the completed diffuser of FIG. 4 combined with light absorbing material;

FIG. 6 illustrates a top view of the diffuser of FIG. 5;

FIG. 7 illustrates an exemplary direct view liquid crystal display incorporating the diffuser of FIG. 5; and

FIG. 8 illustrates an exemplary rear projection display incorporating the diffuser of FIG. 5.

### DETAILED DESCRIPTION

Exemplary diffusers according to present invention include a structure with diffusing elements and other elements, such as waveguides. The diffusing elements diffuse light passing through the diffusing elements and may include matrix or binding material and scattering material or other suitable materials. The scattering material is dispersed in the matrix or binding material. The refractive indices of scattering material and matrix or binding material differ at least by 0.005. The diffusing elements also may be elements with a rough surface wherein the scattering material is air or another medium. The other elements provide at least one function other than diffusing light passing through. When the other elements are waveguides, light entering the waveguides may be directed to certain defined directions by the waveguides and diffused by the diffusing elements. A portion of the material in the diffusing elements is crosslinked to a portion of the material forming the other elements such that there is no macroscopic distinctive boundary between diffusing elements and the other elements. The materials for the diffusing elements and the other elements also may be selected so that there is no optical boundary between the diffusing elements and the other elements.

Exemplary diffusing elements according to the present invention may be formed through radiation induced polymerization of a mixture of materials including polymerizable material. In the case the mixture of materials is a homogenous mixture of polymerizable materials or combination of polymerizable material and non-polymerizable materials, phase separation takes place between polymeirzable materials or polymerizable material and non-polymerizable material. The materials of different phases have refractive indices that differ by at least 0.005. Light is scattered from such a diffusing element due to the existence of phase boundaries. In the case the mixture of materials contains polymerizable material and another material or combination of materials such as glass beads (which may be spherical or non-spherical in shape), solid or colloidal polymeric particles, or solid or colloidal non-polymeric particles, the radiation induced polymerization locks the position of such another material in the polymer matrix. The refractive indices of the polymer matrix and the particles differ by at least 0.005 and light scatters from the boundaries of polymer matrix and the particles.

The mixture of materials may be coated onto a surface where diffusing elements are to be constructed. The coating may be performed with conventional coating technologies, such as slot die coating, doctor blade, and spin coating, or any other suitable technology.

The diffusing elements may be constructed along with waveguide array structures. Diffusers with this configuration direct light through waveguide array structures and spread light to viewers by the diffusing elements which are formed on the output sides of the waveguide elements of a waveguide array.

When a diffuser includes diffusing elements and a waveguide array, the diffusing elements and waveguide array may be constructed in the same fabrication process. For example, a mixture of materials for forming diffuser elements may be deposited from one of the slots in a dual slot coater and the material(s) for forming the waveguide array may be deposited from the other slot of the dual slot coater. If the slot die travels in a coater, the first slot in the moving direction may be used to deposit the material(s) for forming the waveguide array and the second slot may be used to deposit the mixture of materials for forming the diffuser elements. Both coatings may be done at the same time. By selecting the materials for diffusing elements and the waveguide array with matched refractive indices and proper interfacial properties, the two coatings effectively form a “single” layer. This “single” layer may then be polymerized by irradiation, resulting in diffusing elements in the upper portion and waveguides in the lower portion. The polymerization of the “single” layer may be performed through a pre-designed mask to selectively form desired structure (e.g., a waveguide capped with a diffusing element). The mixture of materials for diffusing elements may include polymer or low molecular weight organic materials which are soluble in the polymerizable materials, or solid, colloidal, or liquid materials or particles which are insoluble in the polymerizable materials, or the combination of above. The soluble materials may be liquid crystalline or other materials that undergo phase separation or otherwise form a polymer dispersed liquid crystal type of film. After polymerization of the “single” polymerizable layer, the unpolymerized material may stay embedded or be removed and additional elements, layers and the like may be formed.

Alternatively, the “single” polymerizable layer may include additional layers. These additional layers may be additional diffuser forming layers or may form other layers. Also, the “single” polymerizable layer may have surface textures, such as microlenses, on one or both surfaces of the “single” polymerizable layer.

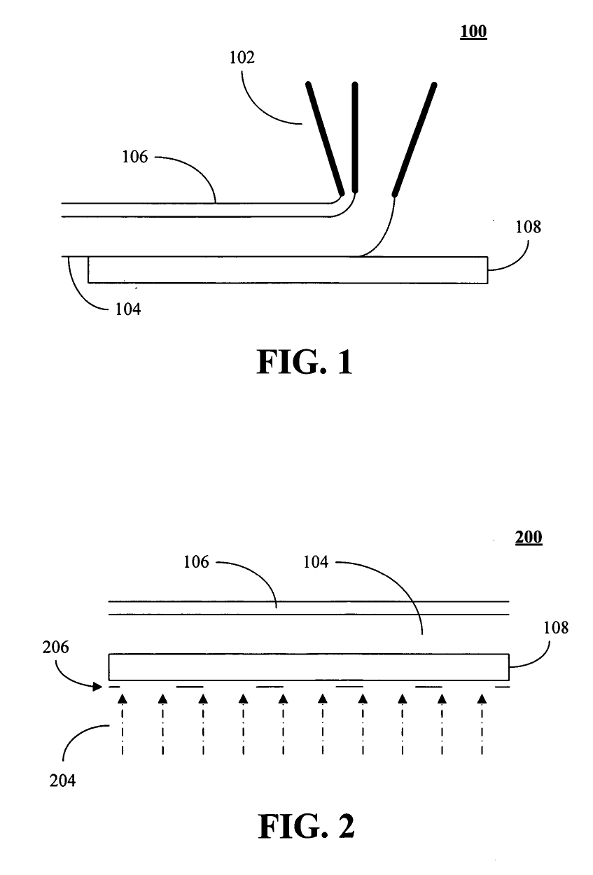

FIG. 1 illustrates a first step 100 of forming an exemplary diffuser according to the present invention. In this first step 100, a “single” layer is deposited from a coating head 102 having first and second slot. The first slot deposits a lower portion 104 while the second slot deposits an upper portion 106 of the “single” layer. The lower and upper portions 104, 106 are deposited on a support structure 108 such as a plastic substrate (e.g., polyethylene terephthalate, polyvinyl alcohol or polymethyl methacrylate), a glass substrate (e.g., borosilicate glass or fused silica glass), or any other suitable structure. The lower portion 104 may be formed from, for example, diacrylate, triacrylate, mixtures of ethoxylated bisphenol A diacrylate and trimethylol propane triacrylate, mixtures of urethane acrylates and methacrylates, mixtures of ester acrylates and methacrylates, mixtures of epoxy acrylates and methacrylates, mixtures of (poly)ethylene glycol acrylates and methacrylates and vinyl containing organic monomers, other optically clear materials or mixtures. The upper portion 106 may be formed from a material mixture containing the same material(s) that the lower portion 104 is formed from or may be formed from compatible material(s). However, the upper portion 106 also may include materials having noticeable difference (e.g., greater than 0.005) in refractive indices from other materials used to form the upper portion 106. These materials may be selected from the class of materials forming the lower portion 104, but have noticeable refractive index difference and phase separated from the other material or materials forming the upper portion 106. These materials also may be materials having a liquid crystalline structure, or non-radiation polymerizable materials such as, epoxy, polybutadiene resin, styrene/maleic anhydrides resin, or any other suitable material or materials. These materials may further include spherical or non-spherical polystyrene particles, polyamide particles, glass beads, or other polymeric, colloidal, organic or inorganic particles.

FIG. 2 illustrates a second step 200 of forming an exemplary diffuser according to the present invention. In this second step 200, collimated or nearly collimated radiation 204 illuminates a photomask 206 such that the “single” layer is selectively polymerized. The collimated or nearly collimated radiation may be ultraviolet (UV) or visible light. The lower portion 104 and the upper portion 106 of the “single” layer are polymerized in the same exposure. Instead of a photomask 206, other exposure systems, such as a scanning laser system, may also be used to polymerize the “single” layer.

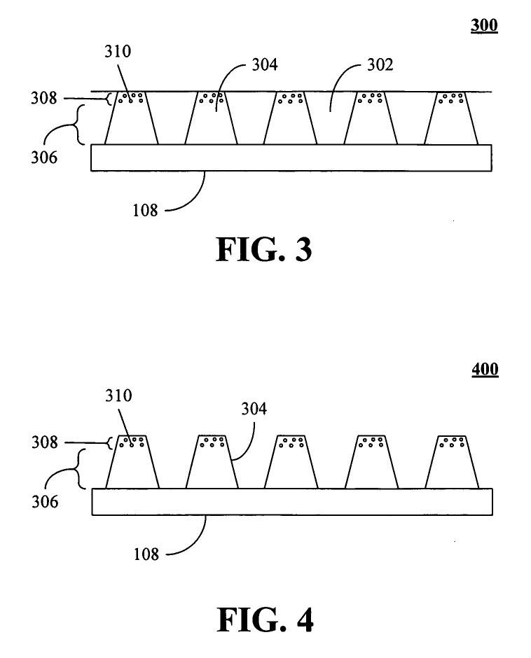

FIG. 3 illustrates a partially completed diffuser 300 after completion of the second step 200. The partially completed exemplary device 300 includes unpolymerized area 302 and polymerized area 304. The polymerized area 304 includes two parts. The first part 306 is formed from the polymerized material of the lower portion 104 and the second part 308 is formed from the polymerized material of the upper portion 106. The first part 306 may form a waveguide array due to the self-focusing or refractive index change during the polymerization. The second part 308 includes pockets of scattering material 310 having a refractive index different from that of matrix materials in the second part 308. The formation of pockets of scattering material 310 may result from polymerization induced phase separation, or insoluble particles embedded in the mixture of materials forming the upper layer 106. The first and second parts 306, 308 are formed concurrently during the exposure to radiation in the second step 200. Table 1 lists some exemplary material mixtures for forming the second part 308.

TABLE 1
MATERIAL MIXTURE FORMING THE SECOND PART 308

| | Material(s) forming | |
|---|---|---|
| | the matrix of the | Scattering materials |
| | second part 308 | in the second part 308 |
| 1 | propoxylated(2) neopentyl | phenyl benzoate (liquid crystal) |
| | glycol diacrylate | |
| 2 | trimethylolpropane | phenyl salicylate (liquid crystal) |
| | triacrylate | |
| 3 | trimethylolpropane | 4′-pentyl-4-biphenylcarbonitrile |
| | triacrylate | (liquid crystal) |
| 4 | 2(2-Ethoxyethoxy) ethyl | polystyrene |
| | acrylate | |
| 5 | propoxylated(2) neopentyl | bisphenol A diglycidyl ether |
| | glycol diacrylate | |
| 6 | trimethylolpropane | bisphenol A diglycidyl ether |
| | triacrylate | |
| 7 | polythylene glycol(600) | poly(phenyl glycidyl ether) |
| | diacrylate | |
| 8 | 2(2-ethoxyethoxy) ethyl | ethoxylated (3) bisphenol A |
| | acrylate | diacrylate |
| 9 | polythylene glycol(600) | epoxy acrylate |
| | diacrylate | |
| 10 | trimethylolpropane | glass beads (particles) |
| | triacrylate | |
| 11 | polythylene glycol(600) | polystyrene beads (particles) |
| | diacrylate | |

Exemplary mixtures 1-3 use scattering materials 310 that are liquid crystalline while exemplary mixtures 4 to 9 use scattering materials 310 that are non-liquid crystalline organic materials. Liquid crystalline and non-liquid crystalline organic materials are capable of being dissolved into the matrix forming material of the second part 308 and phase-separated during irradiation induced polymerization. Exemplary mixtures 10 and 11 use solid glass beads or polystyrene beads as the scattering material 310. The weight concentration of the scattering material 310 in the mixtures ranges from 0.5% to 80%.

In preparing mixtures for the second part 308, a photoinitiator or combination of photoinitiators may be used to introduce radicals under the irradiation of UV or visible light and start the polymerization. Exemplary photoinitiators include benzyl dimethyl ketal, 1-hydroxy-cyclohexyl-phenyl-ketone, 2-hydroxy-2-methyl-1-phenyl propanone, isopropyl thioxanthone, benzoin normal butyl ether, 4-methylbenzophenone, trimethyl benzophenone. The weight concentration of photoinitiator in the mixtures ranges from 0.05% to 10%.

The polymerized structure 304 which forms the waveguide array may be tapered rectangular cones, tapered cubic cones, tapered circular cones, tapered elliptical cones, tapered rectangular stripes, tapered circular stripes, untapered rectangular cones, untapered cubic cones, untapered circular cones, untapered elliptical cones, untapered rectangular stripes, untapered circular stripes or any other suitable geometry. The side walls of the polymerized structure 304 should be smooth so as to provide a highly efficient wave-guide. If there are variations in the polymerized structure 304 that result from diffraction or other light effects, the application of a mechanical oscillation during polymerization may be used to reduce these variations and improve the light throughput.

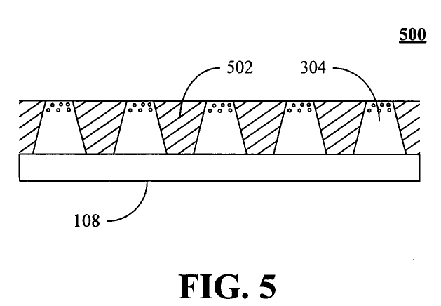

FIG. 4 illustrates an exemplary diffuser 400 after removal of the unpolymerized material 302. FIG. 5 illustrates another exemplary diffuser 500 incorporating the diffuser 400 combined with light absorbing material 502 to improve contrast in the presence of ambient light. This diffuser 500 is formed by depositing the light absorbing material 502 between areas of the polymerized structure 304. The light absorbing material 502 may be any suitable material or combination of materials. For example, the material may be a resinous and/or polymeric material or materials with light absorbing material incorporated therein. Suitable light absorbing materials include carbon black, carbon nanotubes, fullerenes and/or fullerides and any other suitable materials. The light absorbing material may be combined with a wide range of resinous and/or polymeric materials to form light absorbing material 502. The resinous and/or polymeric materials include both natural and synthetic polymeric materials and may be thermoplastic, thermoset, or ultra-violet (UV) curable. For example, suitable materials include, but are not limited to, fluoropolymers, silicones, polystyrenes, polycarbonates, polyetherimides, ethylene vinyl acetates, polypropylenes, polyethylene terephthalates, polybutylene terephthalates, nylons, polyetherketones, polyphenylene sulfides, polyimides, polyvinyl chlorides, acrylics, phenolics, polyesters, polyparaphenylenes, polyanilines, and the like. Additionally, the polymeric material may be conductive polymeric material (e.g., polyparaphenylenes and polyanilines) to increase the conductivity of the light absorbing material, increase the absorbance of light and bind the light absorbing material 502 and the diffuser to other devices. The resinous or polymeric material may be a mixture of two or more resins or polymers.

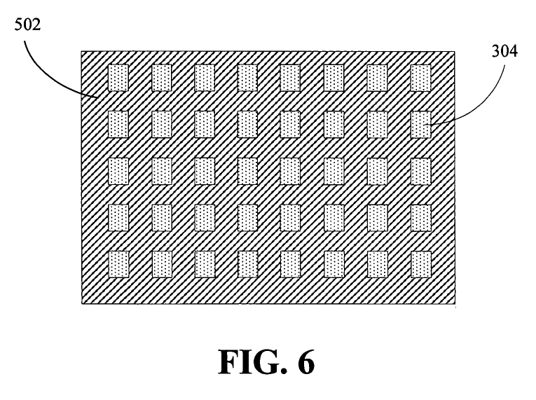

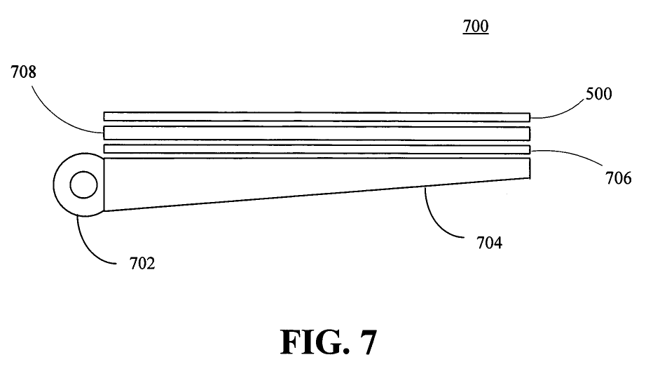

FIG. 6 illustrates a top view of the diffuser 500 of FIG. 5.

FIG. 7 illustrates an exemplary direct view liquid crystal display 700 incorporating the diffuser 500 of FIG. 5, a light source 702 such as cold or hot cathode fluorescent light tube, a light guide 704, collimating assembly 706 and an image generating element 708 such as a twisted nematic liquid crystal display. The light generated from the light source 602 may be partially guided and diffused in the light guide 704. The light exiting the light guide 704 enters the collimating assembly 706 to be homogenized and have a distribution around normal direction of the direct view liquid crystal display 700. The collimating assembly 706 may include a prismatic brightness enhancement film such as a brightness enhancement film from 3M Corp of Minnesota. Light passing through collimating assembly 706 then enters the image generating element 708 that includes a liquid crystal modulator. The light containing the image information is spread to large range of angles by the diffuser 500. Backscattering from ambient light is significantly reduced due to the fact that high percentage of the diffuser surface area is covered by light absorbing material. Alternatively, direct view display may be made with non-liquid crystal modulators.

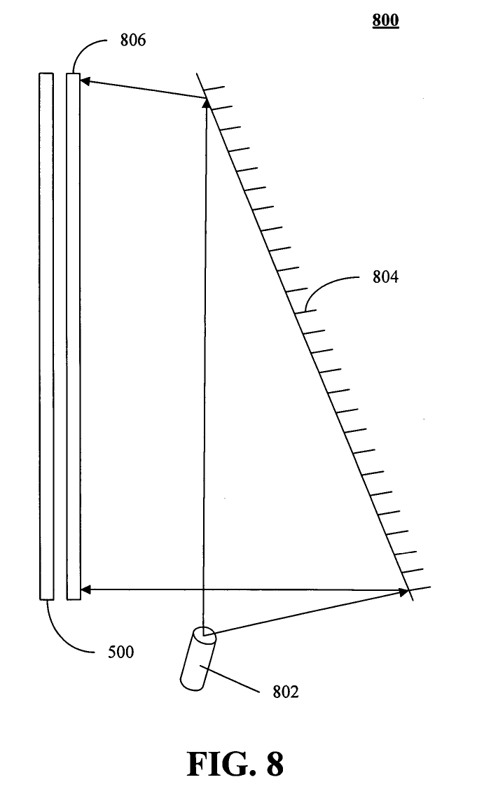

FIG. 8 illustrates an exemplary rear projection display 800 incorporating the diffuser 500 of FIG. 5, a light projection system 802, a mirror 804, a Fresnel lens 806. The light projection system 802 projects an image which is reflected by the mirror 804, through the Fresnel lens 806 and then onto the diffuser 500. The diffuser 500 spreads light over a large angular range such that viewers may view the display 800 over a large angular range. Furthermore, viewers see a high contrast ratio image because backscatter from ambient light is significantly reduced by the light absorbing material 502 of the diffuser 500.

Although several embodiments of the present invention and its advantages have been described in detail, it should be understood that changes, substitutions, transformations, modifications, variations, permutations and alterations may be made therein without departing from the teachings of the present invention, the spirit and the scope of the invention being set forth by the appended claims.

What is claimed is:

1. A diffuser structure comprising:
a structure having at least a first part and a second part, the first part diffusing light passing through the first part and including at least a first material, the second part providing at least one function other than diffusing light passing through the second part and including at least a second material,
wherein at least a portion of the at least a first material adjacent the second part is crosslinked to at least a portion of the at least a second material adjacent the first part.

2. The structure of claim 1, wherein the first part includes polymerized material and non-polymerized material.

3. The structure of claim 2, wherein the non-polymerized material is liquid crystal material.

4. The structure of claim 2, wherein the non-polymerized material is non-liquid crystalline organic material.

5. The structure of claim 2, wherein the non-polymerized material includes at least one of glass beads, or solid or colloidal particles.

6. The structure of claim 1, wherein the first part includes at least two polymerized materials having a refractive index differing by at least 0.005.

7. The structure of claim 1, wherein the at least a first material and the at least a second material are the same material.

8. The structure of claim 1, wherein the at least a first material and the at least a second material are different materials.

9. The structure of claim 1, wherein there is not an optical boundary between the first part and the second part.

10. The structure of claim 1, further comprising a light absorbing material adjacent the structure having at least a first part and a second part.

11. A diffuser structure including integrally formed diffusing elements comprising:
a polymerized structure including a diffusing part and another part, the diffusing part and the another part being integrally formed.

12. The structure of claim 11, wherein the diffusing part includes polymerized material and non-polymerized material.

13. The structure of claim 11, wherein the diffusing part and the another part include the same polymerized material.

14. The structure of claim 11, wherein the diffusing part and the another part include different polymerized materials.

15. The structure of claim 11, wherein an area in a light output side of the diffusing part is smaller than an area of a light input side of the another part.

16. The structure of claim 11, wherein the another part is a polymerized structure and has side walls substantially without diffractive variations.

17. The structure of claim 11, wherein the another part is a waveguide.

18. The structure of claim 11, wherein there is not an optical boundary between the diffusing part and the another part.

19. The structure of claim 11, wherein the diffusing part includes a scattering material.

20. The structure of claim 19, wherein the scattering material is a liquid crystal material.

21. The structure of claim 11, further comprising a light absorbing material adjacent the polymerized structure.

22. A method of forming an integrated diffuser comprising:
depositing a first layer including a first polymerizable material and another material;
depositing a second layer including a second polymerizable material adjacent the first layer; and
simultaneously irradiating the first layer and the second layer with light that causes the first polymerizable material and the second polymerizable material to polymerize,
wherein the another material causes light diffusion once the first polymerizable material is polymerized by the simultaneously irradiating.

23. The method of claim 22, wherein the another material is polymerizable material.

24. The method of claim 22, wherein the another material is non-polymerizable material.

25. The method of claim 22, wherein the first polymerizable material and the second polymerizable material are the same polymerizable material.

26. The method of claim 22, wherein the first polymerizable material and the second polymerizable material are different polymerizable materials.

27. The method of claim 22, wherein a mechanical oscillation is applied to the first layer and the second layer during the simultaneously irradiating the first layer and the second layer with light.

28. The method of claim 22, wherein the first layer forms optical diffusing elements and the second layer forms a waveguide after the simultaneously irradiating the first layer and the second layer with light.

29. The method of claim 22, wherein there is not an optical boundary between the first layer and the second layer after the simultaneously irradiating the first layer and the second layer with light.

30. The method of claim 22, wherein the another material is a liquid crystal material.

31. The method of claim 22, wherein the first layer is a polymer dispersed liquid crystal layer after being irradiated with light.

32. The method of 22, wherein the another material is non-liquid crystalline organic material.

33. The method of claim 22, wherein the simultaneously irradiating the first layer and the second layer with light cause phase separation in the first layer

34. The method of claim 22, further comprising removing portions of the first layer and the second layer that are unpolymerized after the simultaneously irradiating the first layer and the second layer with light; and
depositing a light absorbing material adjacent the portions of the first layer and the second layer that are polymerized after the simultaneously irradiating the first layer and the second layer with light.

35. The method of claim 22, wherein the depositing a first layer and the depositing a second layer are performed in a single deposition.

36. The method of claim 22, wherein the depositing a first layer and the depositing a second layer are performed in sequential depositions.
